(19) United States
(12) Patent Application Publication
(10) Pub. No.: US 2024/0428005 A1
(43) Pub. Date: Dec. 26, 2024

(54) GENERATING GROUNDED DOCUMENTS USING LARGE LANGUAGE MODELS

(71) Applicant: Microsoft Technology Licensing, LLC, Redmond, WA (US)

(72) Inventors: Robin ABRAHAM, Redmond, WA (US); Mingyang XU, Kenmore, WA (US); Julia CHEN, Bellevue, WA (US); Yijian XIANG, Redmond, WA (US); Manqing MAO, Kenmore, WA (US); Jianzhe LIN, Bellevue, WA (US); Paishun TING, Kirkland, WA (US); Liang DU, Redmond, WA (US)

(21) Appl. No.: 18/211,808

(22) Filed: Jun. 20, 2023

(51) Int. Cl. G06F 40/40; G06F 16/33; G06F 40/177

(52) U.S. Cl. CPC G06F 40/40; G06F 16/3344; G06F 40/177

(57) ABSTRACT

The present disclosure relates to methods and systems for automatically generating documents for a specific topic using large language models. The methods and systems receive an input query that identifies a topic for the document. The methods and systems automatically generate, using the large language models, a framework for the document with sections and subsections for the document. The methods and systems write the document, using the large language models, and provide references for the data sources used to obtain the data that the large language model used to write the document.

### BACKGROUND

Large language models (LLMs) have become increasingly popular due to their ability to generate fluent and coherent text in response to various input prompts. Advancements in LLMs have enabled new products and services, new business models, and efficiencies in business processes across various domains. LLMs face challenges in generating accurate and reliable outputs, often producing false or incorrect information, referred to as hallucinations. This severely affects the reliability and trustworthiness of the LLMs.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Some implementations relate to a method. The method includes receiving an input query with a topic for a document. The method includes generating, by a large language model, a framework with sections and subsections for the document. The method includes writing, by the large language model, the sections and the subsections of the document with natural language and references to data sources used to obtain data that the large language model used to write the document. The method includes providing the document in response to the input query.

Some implementations relate to a device. The device includes a processor; memory in electronic communication with the processor; and instructions stored in the memory, the instructions being executable by the processor to: receive an input query with a topic for a document; generate, by a large language model, a framework with sections and subsections for the document; write, by the large language model, the sections and the subsections of the document with natural language and references to data sources used to obtain data that the large language model used to write the document; and provide the document in response to the input query.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 illustrates an example environment for automatically generating documents in accordance with implementations of the present disclosure.

FIG. 2 illustrates an example of generating a framework for a document in accordance with implementations of the present disclosure.

FIG. 3 illustrates an example of searching data sources before writing a document in accordance with implementations of the present disclosure.

FIG. 4 illustrates an example of writing with references in a document in accordance with implementations of the present disclosure.

FIG. 5 illustrates an example method for automatically generating a document in accordance with implementations of the present disclosure.

FIG. 6 illustrates an example method for automatically generating a document in accordance with implementations of the present disclosure.

FIG. 7 illustrates components that may be included within a computer system.

### DETAILED DESCRIPTION

Large language models (LLMs) have achieved significant advancements in various natural language processing (NLP) tasks. LLMs refer to machine learning artificial intelligence (AI) models that can generate natural language text based on the patterns they learn from processing vast amounts of data. LLMs use deep neural networks, such as transformers, to learn from billions or trillions of words, and to produce text on any topic or domain. LLMs can also perform various NLP tasks, such as classification, summarization, translation, generation, and dialogue.

LLMs have demonstrated a remarkable ability in generating fluent and coherent text in response to various input prompts (e.g., questions or dialog). Advancements in LLMs have enabled new products and services, new business models, and efficiencies in business processes across various domains. One example of new products and services is copilots that help amplify the capabilities of humans performing specific types of tasks. For example, a copilot helps developers work more efficiently by generating code from descriptions, generating documentation, and helping look up functions. Another example includes a copilot allowing users to do multi-turn interactions with a search engine and get results surfaced directly within the chat (with links to sources), thereby saving the users the effort of having to browse multiple links looking for the relevant information. Another example includes a copilot reducing the manual intervention required in productivity tasks.

However, in some instances, the generated output from the LLM is not factually correct or in other words, the output hallucinates. A hallucination is the generation of a false or incorrect output of the LLM. For example, an incorrect answer or nonsensical text. That is, even if the LLM does not have the correct answer for a query, the LLM tends to make up the answer and phrase the answer as a highly confident human would. This severely affects the reliability and trustworthiness of the LLMs.

Existing solutions for addressing hallucinations in LLMs include constraining the model to only return grounded results that are supported by reference. For example, existing chat solutions allow end users to do multi-turn interactions with the search engine and get results surfaced directly within the chat session. These results typically include references to sources on the web, thereby saving the users the effort of having to browse multiple links looking for relevant information. However, providing reference to sources on the web does not guarantee that the information that is being returned in the chat session is accurate. It only means that there are sites on the internet that carry that information.

Existing chat solutions are also limited to the capabilities of the underlying LLMs. LLMs typically support chat sessions that are linear (input-response sequential chains) and are limited to a fixed number of turns. For example, the number of turns in a chat session could be limited to 15 or 20. The context of the LLM is limited to the number of tokens the LLM can support, and the entire session (user inputs and systems responses) needs to be managed within this limitation.

The references for existing chat solutions are limited to public data on the web. Researchers within an enterprise are unable to bring in their documents and/or references and have their documents incorporated into the responses. In addition, existing solutions are unable to constrain the responses to a corpus of documents and/or publications.

Research activities need support beyond linear evolution of chat over limited context. A researcher is not following a specification and does not start or resume a research activity with a set of questions that lead to a desired outcome after a set number of turns. Researchers may generate reports on a given topic during research activities. The reports are generally written by experts on the topic and may be lengthy (up to hundreds of pages).

The methods and systems use one or more LLMs to automatically generate a document in response to user prompts. In some implementations, the document is a survey or research summary in response to the user prompts. A survey is a document that captures the state of the art in a field, area, or approach, and cites references of work that has already been published. For example, a survey on the best practices in prompt engineering for LLMs. In some implementations, the document is a report. A report is a document that contains detailed information that is gathered through observation, study, or other research. A report is the output of some research activity and typically describes the problem, approach, evaluation, results, and related work. Reports also cite prior art to the extent they overlap or provide context, but summarizing prior art is not the sole purpose. For example, a report on a new approach for training LLMs. In some implementations, the methods and systems receive a user prompt (e.g., a topic or question) and use one or more LLMs to generate a grounded technical document on the topic or question with reference to the data sources used in preparing the technical document.

The methods and systems use one or more LLMs to generate a document framework with various sections and subsections for the document. The user has an option to review the document framework and make any modifications to the framework. One or more LLMs fills in the various sections, subsections with natural language. The LLM(s) provide references for the data sources used to obtain the data that the LLM(s) used to write the document.

In some implementations, the user prompt includes the input describing what topic to write the document on along with additional information on areas of focus for the topic. For example, a user asks for a report on recent advances in treatment of lung cancer, but with specific focus on results of clinical trials of immunotherapy protocols. This input prompts the LLM(s) to generate more content summarizing results from across papers that are retrieved on the topic of lung cancer treatments that also include immunotherapy.

In some implementations, the user prompt includes the topic for the document and a selection of a specific set of sources to use for generating the document. For example, the user asks for the document to be generated using data from a set of trusted sources (patents, PubMed, etc.). In some implementations, the user prompt includes the topic for the document and a selection of input documents to use for generating the document.

The present disclosure includes several practical applications that provide benefits and/or solve problems associated with using LLMs to automatically generate documents (reports, contracts, funding proposals, clinical trial protocols, product documentation, agreements, etc.). The methods and systems allow users to receive input-customized, grounded, expert summaries or surveys generated on the fly by the LLMs for questions and topics included in an input query.

One technical advantage of the system and methods of the present disclosure is using LLMs to automatically generate documents with references to the data source given a topic for the documents. Another technical advantage of the systems and methods of the present disclosure is limiting the data sources (public or private data source, recent 5 years or past 20 years data sources, only from specific journals, etc.) used by the LLMs in generating the documents. Another technical advantage of the systems and methods of the present disclosure is providing references to the specified data sources used to obtain the data that the LLMs used to write the document and additional information with areas of focus for the topic is also provided.

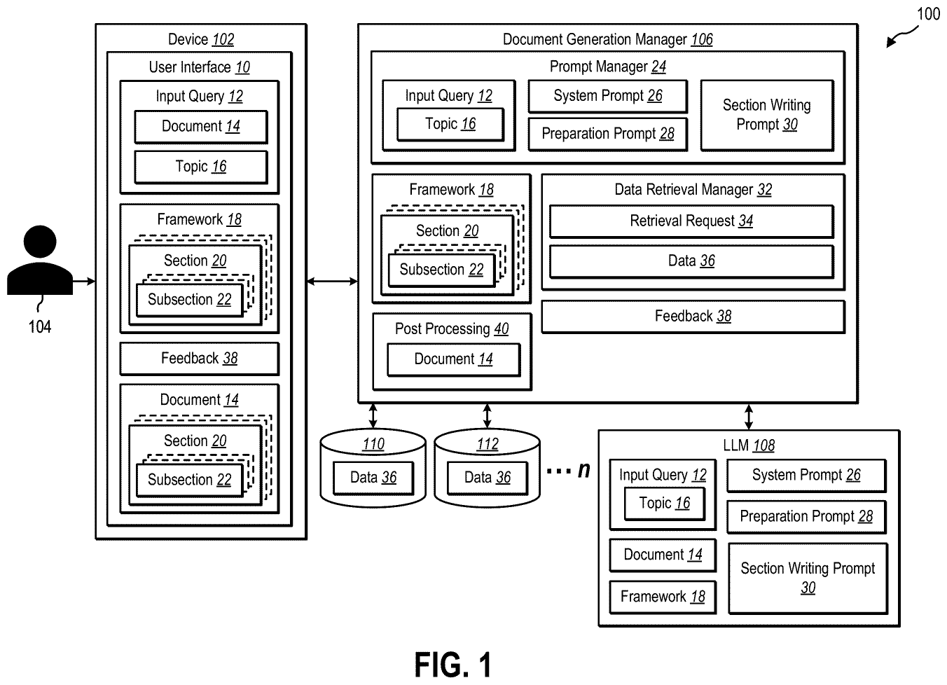

Referring now to FIG. 1, illustrated is an example environment 100 for use with automatically generating documents 14. The environment 100 includes a document generation manger 106 that uses one or more LLMs 108 to automatically generate a document 14 and write the document 14 with natural language in response to an input query 12 requesting a document 14 for a specific topic 16. Examples of the LLM 108 include BERT, XLNET, LaMDA, LLaMA, MT-NLG, PaLM, GPT-3, ChatGPT, GPT-4.

The document generation manager 106 is accessible to a user 104 using a user interface 10 on a device 102 of the user 104. In some implementations, a plurality of devices 102 are in communication with the document generation manager 106 and a plurality of users 104 have access to the document generation manager 106.

In some implementations, the document generation manager 106 is on a server (e.g., a cloud server) remote from the device 102 of the user 104 accessed via a network. The network may include the Internet or other data link that enables transport of electronic data between respective devices and/or components of the environment 100. For example, a uniform resource locator (URL) configured to an end point of the document generation manager 106 is provided to the device 102 for accessing the document generation manager 106. In some implementations, the document generation manager 106 is local to the device 102 of the user 104.

The user interface 10 is presented on a display of the device 102 and the user interface 10 includes an area to receive an input query 12 from the user 104 requesting generation of a document 14 for a topic 16. The input query 12 includes natural language text. The input query 12 may be natural language sentences, questions, code snippets or commands, or any combination of text or code, depending on the domain and the task. The topic 16 includes any themes or ideas as the subject of the document 14 as indicated by the user 104. In some implementations, the document 14 is a report. In some implementations, the document 14 is a technical survey report. Other examples of the document 14 include contracts, funding proposals, clinical trial protocols, and product documentation.

One example input query 12 with a topic 16 includes “generate a report for me on the trend of breast cancer treatment development in the next 5 years.” Another example input query 12 with a topic 16 includes “generate a clinical trial protocol for a type of molecule X targeting condition Y.”

In some implementations, the input query 12 includes additional information with areas of focus for the topic that is used by the LLM 108 to generate the document 14. An example of the input query 12 with an area of focus includes “a request for a report on recent advances in treatment of lung cancer, but with specific focus on results of clinical trials of immunotherapy protocols.” The input query 12 prompts the LLM 108 to generate more content summarizing results from across papers that are retrieved on the topic of lung cancer treatments that also include immunotherapy.

In some implementations, the input query 12 includes a data source 110, 112 or a set of data sources 110, 112 to use in generating the document 14. An example of the input query 12 with a set of data sources 110, 112 identified includes “a request for a survey report to be generated on the side effects of a medicine on patients with diabetes using information from PUBMED only.” Another example of the input query 12 with a set of data sources 110, 112 identified includes “a request to prepare a report on the side effects of a medicine on patients with diabetes using documents from clinical trials conducted by an organization.” The input query 12 restricts the data 36 available to the LLM 108 to use in generating the document 14 to the data sources 110, 112 identified in the input query 12.

The input query 12 and topic 16 are provided to a prompt manager 24. The prompt manager 24 generates input prompts to provide to the LLM 108. The input prompts are the inputs or queries that a user or a program gives to the LLM 108, in order to elicit a specific response from the LLM 108 in response to the input prompt.

In some implementations, the prompt manager 24 generates a system prompt 26 to provide to the LLM 108. The system prompt 26 has pre-defined default instructions. For example, defining the role of LLM and defining the goal for the task including the topic 16. The system prompt 26 can also be customized by user 104 to be use case specific. The system prompt 26 provides additional instructions to the LLM 108 for preparing the document 14 using the input query 12. For example, the additional instructions provide a chain of thought to the LLM 108 for writing the document 14 (e.g., write the report step by step). Another example of the additional instructions includes “follow my instructions step by step.” Another example includes the additional instructions provide a goal for the document 14. Another example includes the additional instructions provide a length for the document 14.

In some implementations, the document 14 includes a table of content and the prompt manager 24 generates a table of content prompt to provide to the LLM 108. The table of content prompt provides additional instructions to the LLM 108 for preparing the table of content. For example, the table of content prompt includes instructions to first write down the title of the document 14, provide a topic of each chapter to include in the table of content, provide a topic of each section included in the table of content, and provides a format for the LLM 108 to use in preparing the table of content.

The prompt manager 24 provides the user input query 12 with the topic 16 and the system prompt 26 to the LLM 108. In some implementations, the prompt manager 24 provides the user input query 12 with the topic 16, the system prompt 26, and the table of content prompt to the LLM 108. The LLM 108 uses the input query 12 and the topic 16 and any prompts provided by the prompt manager 24 (the system prompt 26 and/or the table of content prompt) in generating a framework 18 for the document 14.

The framework 18 includes the sections 20 and the subsections 22 the LLM 108 determined for the document 14. The sections 20 and/or subsections 22 include a description for each section 20 and/or subsection 22. In some implementations, the sections 20 and/or subsections 22 include tables or figures. The framework 18 provides an outline of the document 14. In some implementations, the framework 18 is a table of content with the sections 20 and/or subsections 22 for the document 14.

The framework 18 is presented on the user interface 10 in response to the input query 12. The user 104 may review the framework 18 for the document 14 and provide feedback 38 for the framework 18. One example of the feedback 38 is modifying the framework 18. Examples of modifying the framework 18 include adding a section 20, adding a subsection 22, removing a section 20, removing a subsection 22, editing a description of a section 20, or editing a description of a subsection 22.

Another example of the feedback 38 is requesting a new framework 18 for the document 14. Another example of the feedback 38 is accepting the framework 18. The user 104 is able to review and/or modify the framework 18 generated by the LLM 108 for the document 14 prior to creation of the document 14 by the LLM 108.

Any feedback provided by the user 104 on the framework 18 is used by the LLM 108 in preparing the document 14. The document generation manager 106 provides the feedback 38 to the LLM 108. For example, if the user 104 approves the framework 18, the LLM 108 uses the framework 18 in generating the document 14. Another example includes if the user 104 modifies the framework 18, the LLM 108 uses the modified framework in generating the document 14.

In some implementations, the prompt manager 24 generates a preparation prompt 28 to provide to the LLM 108. The preparation prompt 28 has pre-defined default instructions; similar to the system prompt 26. For example, the preparation prompt 28 instructs the LLM 108 to identify which previous sections of the generated document 14 are needed to generate coherent content for the current section. The preparation prompt 28 also instructs the LLM 108 to identify what information is needed from the data source in order to write the current section. The preparation prompt 28 provides additional information to the LLM 108 for preparing the document 14. For example, the additional information asks questions about what is necessary (data to use or previous sections that a section depends on) to write different sections of the document. Another example of the additional information is which previous sections of the generated report are needed to generate coherent content for the current section.

In some implementations, the LLM 108 uses the preparation prompt 28 and the framework 18 to identify the information the LLM 108 needs to prepare the document 14. The information the LLM 108 needs is formulated as the retrieval request 34 by the data retrieval manager 32. The retrieval request 34 identifies the data sources 110, 112 (up to n, where n is a positive integer) for use in preparing the document 14. The data retrieval manager 32 retrieved the data 36 from the data sources 110, 112 in response to the information requested by LLM 108.

A data retrieval manager 32 accesses one or more data sources 110, 112 (up to n, where n is a positive integer) and provides the retrieval request 34 to the data sources 110, 112 for obtaining the data 36. The data 36 is provided to the LLM 108 for use in preparing the document 14.

In some implementations, the data sources 110, 112 are publicly available data sources 110, 112 with publicly available data 36. Examples of publicly available data sources 110, 112 include scientific journals, scientific documents, patent filings, publications, news, earnings reports, company information, knowledge graphs, mapping information, photographs, biomedical information, clinical data, administrative information, regulations, or geographic data.

In some implementations, the data sources 110, 112 are private data sources 110, 112 with private data 36 unavailable to the public. One example of a private data source 110, 112 is an organizational data source with private data, such as, research notes, lab documents, business processes, manufacturing processes, employee information, trade secrets, and/or experimental data. Another example of private data sources 110, 112 include data sources with prebuilt indexes, such as, search indexes, embeddings for a domain, and/or knowledge graphs for a domain.

In some implementations, the data sources 110, 112 include a combination of publicly available information and private information unavailable to the public. For example, the data source 110 has data 36 from a publicly available data index and the data source 112 has data 36 from a private search index.

In some implementations, the prompt manager 24 generates a section writing prompt 30 to provide to the LLM 108. The section writing prompt 30 has pre-defined default instructions. For example, given the data 36, the framework 18, the section 20, and the subsection 22 along with their summaries, the section writing prompt 30 instructs the LLM 108 to use the above information to write the current section. The information in the section writing prompt 30 includes the final instruction for writing the section 20, which includes the relevant data 36 retrieved from the data retrieval manager 32, the framework 18, previous sections needed, and instructions on how to write the section, such as steps, and format. The section writing prompt 30 provides additional instructions to the LLM 108 for writing the document 14.

The LLM 108 uses the data 36 and any prompts provided (the input query 12 with the topic 16, the table of content prompt, the system prompt 26, the preparation prompt 28, and/or the section writing prompt 30) to the LLM 108 to write the sections 20 and the subsections 22 of the framework 18 of the document 14. The LLM 108 writes the sections 20 and the subsections 22 of the framework with natural language using the data 36. The LLM 108 provides references to the data sources 110, 112 used in writing the sections 20 and the subsections 22. For example, the references to the data sources 110, 112 includes citations to the data sources 110, 112. In some implementations, the references to the data sources 110, 112 correspond to a list of references generated by the LLM 108 at the end of the document 14 (e.g., a number that identifies the reference in the list of references). In some implementations, the sections 20 and/or the subsections 22 also include figures, graphs, and/or tables automatically generated by the LLM 108.

The LLM 108 iteratively updates the content, figures, graphs, and/or tables of the document 14 in response to the retrieved data 36 from the data retrieval manager 32 as well as the section 20 and the subsection 22. The LLM 108 provides the document 14 to the document generation manager 106.

The document generation manager 106 performs post processing 40 on the document 14. In some implementations, the post processing 40 includes converting the document 14 to PDF. In some implementations, the post processing 40 includes generating the Reference Section for the document 14 based on the references' id written in the sections 20.

The document generation manager 106 provides the document 14 for presentation on the user interface 10 in response to the input query 12. The user 104 receives an input-customized automatically generated document 14 by the LLM 108 on the fly for the topic 16 provided in the input query 12. By providing the list of references in the document 14, the user 104 may identify the support for the information included in the document 14.

In some implementations, one or more computing devices (e.g., servers and/or devices) are used to perform the processing of the environment 100. The one or more computing devices may include, but are not limited to, server devices, personal computers, a mobile device, such as, a mobile telephone, a smartphone, a PDA, a tablet, or a laptop, and/or a non-mobile device. The features and functionalities discussed herein in connection with the various systems may be implemented on one computing device or across multiple computing devices. For example, the user interface 10, the document generation manager 106, the LLM 108, and the data sources 110, 112 are implemented wholly on the same computing device. Another example includes one or more subcomponents of the user interface 10, the document generation manager 106, the LLM 108, and/or the data sources 110, 112 are implemented across multiple computing devices. Moreover, in some implementations, one or more subcomponent of the user interface 10, the document generation manager 106, the LLM 108, and/or the data sources 110, 112 may be implemented are processed on different server devices of the same or different cloud computing networks.

In some implementations, each of the components of the environment 100 is in communication with each other using any suitable communication technologies. In addition, while the components of the environment 100 are shown to be separate, any of the components or subcomponents may be combined into fewer components, such as into a single component, or divided into more components as may serve a particular implementation. In some implementations, the components of the environment 100 include hardware, software, or both. For example, the components of the environment 100 may include one or more instructions stored on a computer-readable storage medium and executable by processors of one or more computing devices. When executed by the one or more processors, the computer-executable instructions of one or more computing devices can perform one or more methods described herein. In some implementations, the components of the environment 100 include hardware, such as a special purpose processing device to perform a certain function or group of functions. In some implementations, the components of the environment 100 include a combination of computer-executable instructions and hardware.

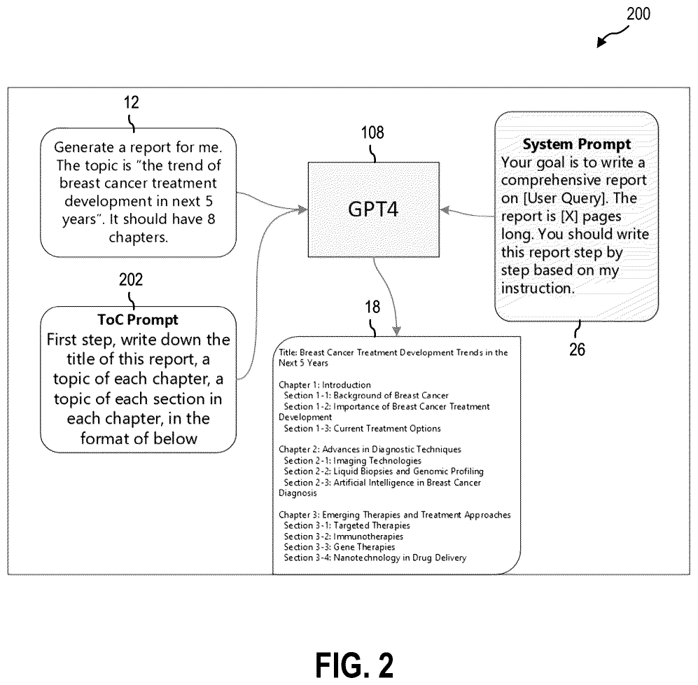

Referring now to FIG. 2, illustrated is an example step 200 for generating a framework 18 for a document 14 (FIG. 1). The document generation manager 106 (FIG. 1) receives the user query 12 to prepare a document 14 (FIG. 1) for a topic 16 (FIG. 1) from the user 104. The user query 12 includes “generate a report for me. The topic is “the trend of breast cancer treatment development in the next 5 years.” It should have 8 chapters.”

The prompt manager 24 (FIG. 1) generates a system prompt 26 in response to the user query 12. The system prompt 26 provides a chain of thought (you should write the report step by step based on my instruction) to the LLM 108 for writing the sections 20 (FIG. 1) and the subsections 22 (FIG. 1) of the document. The system prompt 26 also provides a goal (write a comprehensive report on the trend of breast cancer treatment development in the next 5 years) to the LLM 108 for writing the document 14. The system prompt 26 also identifies a length (8 chapters) of the document 14 for the LLM 108 to prepare.

The prompt manager 24 (FIG. 1) generates a table of content prompt 202 in response to the user query 12. The user query 12 identifies a number of chapters (8) for the document 14. The table of content prompt 202 provides instructions to the LLM 108 for writing the table of content for the document 14. The instructions include “first step, write down the title of this report, a topic of each chapter, a topic of each section in each chapter, in the below format.”

The input query 12, the system prompt 26, and the table of content prompt 202 are provided to the LLM 108. The LLM 108 uses the input query 12, the system prompt 26, and the table of content prompt 202 to generate the framework 18 for the document 14. In some implementations, the framework 18 is a table of content.

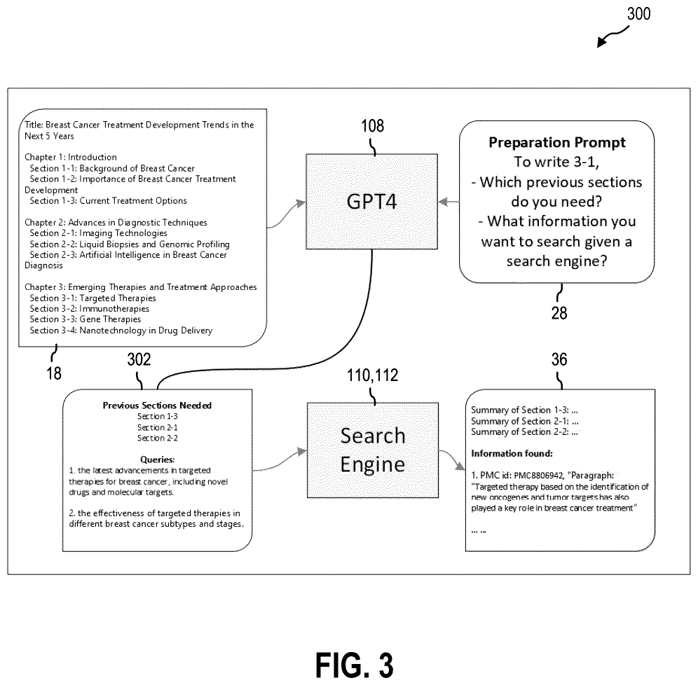

Referring now to FIG. 3, illustrated is an example step 300 for searching data sources 110, 112 (FIG. 1) before writing a document 14 (FIG. 1). The prompt manager 24 (FIG. 1) generates a preparation prompt 28 to identify information needed to prepare the document. For example, the preparation prompt 28 asks the LLM 108 “to write section 3-1, which previous sections do you need? What information do you want to search given a search engine?”

The preparation prompt 28 and the framework 18 are provided to the LLM 108. In some implementations, the framework 18 is a table of content. The LLM 108 uses the preparation prompt 28 and the framework 18 to identify the previous sections 20 (FIG. 1) and/or subsections 22 (FIG. 1) of the framework 18 needed to write the section 3-1. The LLM 108 outputs the information 302 with the previous sections needed in the framework 18 to write the section 3-1.

The data retrieval manager 32 generates a retrieval request 34 to send to one or more data sources 110, 112 for the data 36 (FIG. 1) in response to the information 302. For example, the retrieval request 34 is sent to a search engine and the search engine returns the data 36 in response to the retrieval request 34.

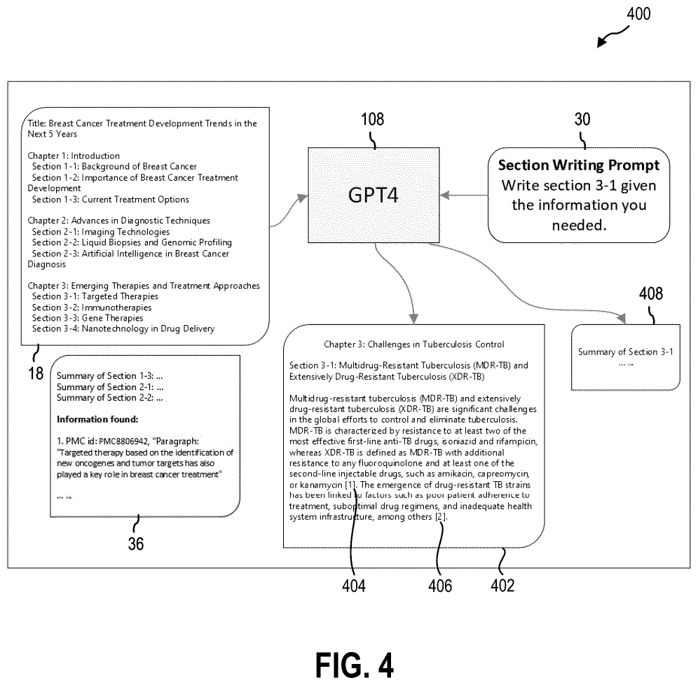

Referring now to FIG. 4, illustrated is an example step 400 for writing with references in a document 14 (FIG. 1). The prompt manager 24 (FIG. 1) generates a writing prompt 30 that provides additional instructions to the LLM 108 for writing the document 14. For example, the additional instructions are “write section 3-1 given the information you needed.” The writing prompt 30, the framework 18, and the data 36 are provided to the LLM 108.

The LLM 108 uses the writing prompt 30, the framework 18, and the data 36 to write the sections 20 (FIG. 1) and the subsections 22 of the framework 18 with natural language. The LLM 108 provides a completed section 402 for the section 3-1 of the framework 18 and a summary 408 of the section 3-1. The completed section 402 includes references 404, 406 to the data sources 110, 112 (FIG. 1) used to obtain the data 36 that the LLM 108 used in generating the completed section 402. In some implementations, the references 404, 406 correspond to a list of references with citations to the data sources 110, 112 at the end of the document 14. In some implementations, the references 404, 406 correspond to footnotes or endnotes in the document 14.

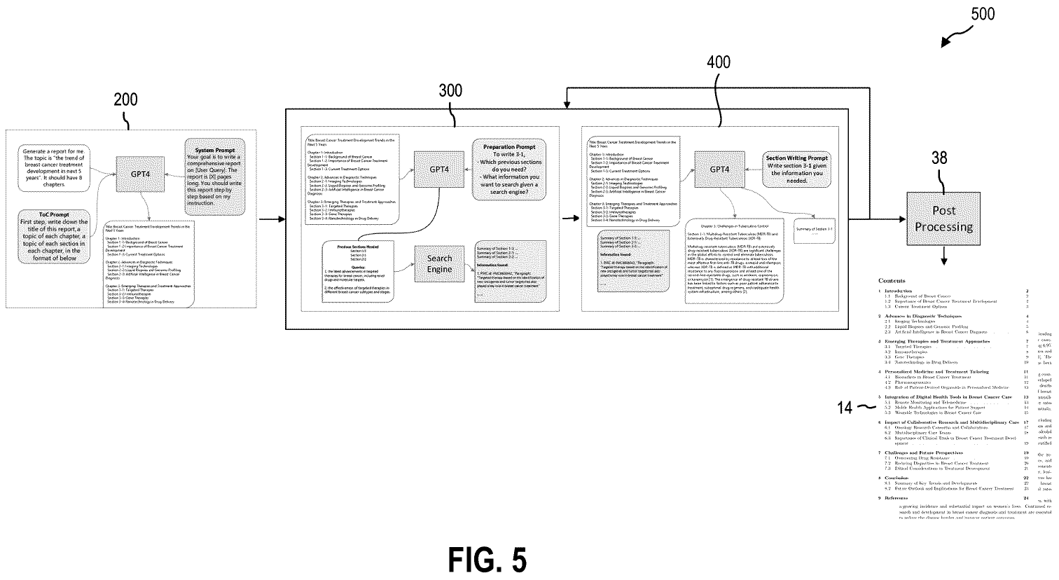

Referring now to FIG. 5, illustrated is an example method 500 for automatically generating a document. The actions of the method 500 are discussed below with reference to FIGS. 1-4.

The method 500 uses one or more LLMs 108 to automatically generate a document 14 in response to an input query 12 provided by the user 104 requesting a document 14 for a topic 16. The method 500 includes the steps 200, 300, and 400 as discussed above in FIGS. 2-4. The method 500 may return to step 300 until all of the sections 20 and the subsections 22 of the framework 18 are written by the LLM 108 in the step 400. The final output of the step 400 is the document 14 with the sections 20 and the subsections 22 filled in with natural language by the LLM 108. In some implementations, the sections 20 and/or the subsections 22 also include figures, graphs, and/or tables automatically generated by the LLM 108.

The document generation manager 106 performs post processing 40 on the document 14. In some implementations, the post processing 40 includes converting the document 14 into a PDF. In some implementations, the post processing 40 includes generating the Reference Section at the end of the document 14. The document generation manager 106 provides the document 14 for generation on the user interface 10 of the device 102 of a user 104. In some implementations, the document 14 includes a comprehensive report on the topic 16. For example, the document includes hundreds of pages automatically generated by the LLM 108 with references to the data sources 110, 112 used to obtain the data 36 used in generating the document 14.

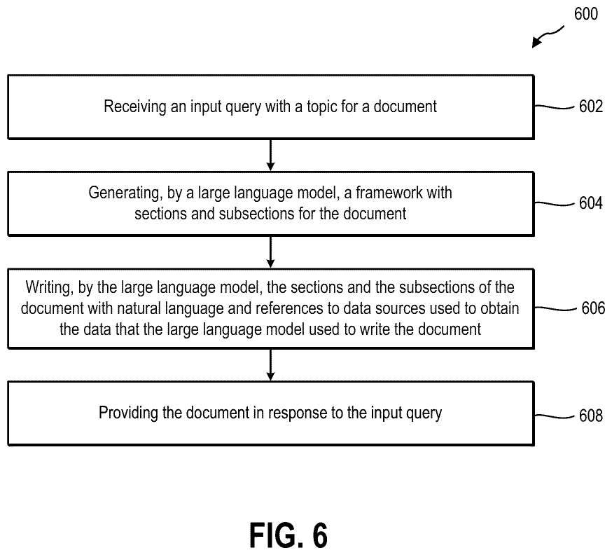

Referring now to FIG. 6, illustrated is an example method 600 for automatically generating a document. The actions of the method 600 are discussed below with reference to FIGS. 1-5.

At 602, the method 600 includes receiving an input query with a topic for a document. An input query 12 is received from a user 104 requesting generation of a document 14 for a topic 16. The input query 12 includes natural language text.

In some implementations, the input query 12 further includes areas of focus for the topic 16 and the document 14 includes additional content for the areas of focus. In some implementations, the input query 12 further includes a set of data sources 110, 112 to use in providing the data 36 for the document 14. In some implementations, the set of data sources 110, 112 are trusted data sources. Trusted data sources include data sources 110, 112 that are known to provide quality (completeness, accuracy, consistency, validity, uniqueness, integrity) information or reliable (authority, credibility, transparency) information. In some implementations, the set of data sources 110, 112 include a combination of publicly available data sources and private data sources. In some implementations, the set of data sources 110, 112 include publicly available data sources 110, 112. In some implementations, the set of data sources 110, 112 include private data sources. The input query 12 may limit the data sources 110, 112 used by the LLM 108 to the data sources 110, 112 identified in the input query 12 in generating the document 14.

At 604, the method 600 includes generating, by an LLM, a framework with sections and subsections for the document. The input query 12 and topic 16 are provided to a prompt manager 24. The prompt manager 24 generates input prompts to provide to the LLM 108. The LLM 108 uses the input query 12 and the topic 16 in creating the framework 18 for the document 14.

In some implementations, the prompt manager 24 provides to the LLM 108 a system prompt 26 that includes a chain of thought for the LLM 108 to use in preparing the document 14, a goal for the LLM 108 to achieve for the document 14, and a length of the document 14. The LLM 108 uses the system prompt 26 in writing the sections 20 and the subsections 22 of the document 14.

The framework 18 includes the sections 20 and the subsections 22 the LLM 108 determined for the document 14. The sections 20 and/or subsections 22 include a description for each section 20 and/or subsection 22. The framework 18 provides an outline of the document 14. In some implementations, the framework 18 is a table of content with the sections 20 and/or subsections 22.

The framework 18 is presented on the user interface 10 in response to the input query 12. The user 104 may review the framework 18 for the document 14 and provide feedback 38 for the framework 18. In some implementations, the document generation manager 106 receives a modification to the framework 18 and the document generation manager 106 generates an updated framework in response to the modification. For example, the user 104 provides a modification to the framework 18. Examples of modifications includes an addition of a section, an addition of a subsection, a removal of a section, a removal of a subsection, editing a section, or editing a subsection. The LLM 108 uses the updated framework to write the sections 20 and the subsections 22 of the document 14.

At 606, the method 600 includes writing, by the LLM, the sections and the subsections of the document with natural language and references to data sources used to obtain the data that the large language model used to write the document.

In some implementations, the prompt manager 24 provides to the LLM 108 a preparation prompt 28 that the LLM 108 uses to identify information needed to prepare the document 14. The LLM 108 uses the preparation prompt 28 to identify the information needed to prepare the document 14. The data retrieval manager 32 sends a retrieval request 34 for the data 36 to use in writing the document 14 in response to the information provided by the LLM 108.

In some implementations, the prompt manager 24 provides to the LLM 108 a section writing prompt 30 that provides additional instructions to the LLM 108 for writing the sections 20 and the subsections 22 of the document 14. The LLM 108 uses the section writing prompt 30 to write the sections 20 and subsections 22 of the document 14.

The LLM 108 uses the data 36 and any prompts (the input query 12 with the topic 16, the table of content prompt, the system prompt 26, the preparation prompt 28, and/or the section writing prompt 30) provided to the LLM 108 to fill in the sections 20 and the subsections 22 of the framework 18 of the document 14 with natural language using the data 36. In some implementations, the sections 20 and/or subsections 22 include tables, graphs, and/or figures automatically generated by the LLM 108 for the document 14.

The LLM 108 provides references to the data sources 110, 112 used in writing the sections 20 and the subsections 22. For example, the references to the data sources 110, 112 includes citations to the data sources 110, 112. In some implementations, the references to the data sources 110, 112 within the sections 20 and the subsections 22 correspond to a list of references generated by the LLM 108 at the end of the document 14 (e.g., a number that identifies the reference in the list of references). The LLM 108 automatically generates a list of references at an end of the document 14 with citations to the data sources 110, 112 used in generating the document 14. In some implementations, the references correspond to footnotes or endnotes in the document 14.

In some implementations, the document 14 is a report. In some implementations, the document 14 is a grounded technical report on the topic 16. Other examples of the document 14 include contracts, funding proposals, clinical trial protocols, and product documentation. In some implementations, the sections 20 or the subsections 22 further include figures or tables automatically created by the LLM 108.

At 608, the method 600 includes providing the document in response to the input query. The LLM 108 provides the document 14 to the document generation manager 106. The document generation manager 106 performs post processing 40 on the document 14. In some implementations, the post processing 40 includes converting the document 14 to PDF. In some implementations, the post processing 40 includes generating the Reference Section for the document 14. The document generation manager 106 provides the document 14 for presentation on the user interface 10 in response to the input query 12.

The method 600 provides the user 104 an input-customized automatically generated document 14 by one or more LLMs 108 on the fly for the topic 16 provided in the input query 12. By providing grounded documents 14 to the user with reference to the data sources 110, 112 used by the LLM(s) 108 in generating the document 14, the user 104 is able to easily identify the support for the information included in the document 14.

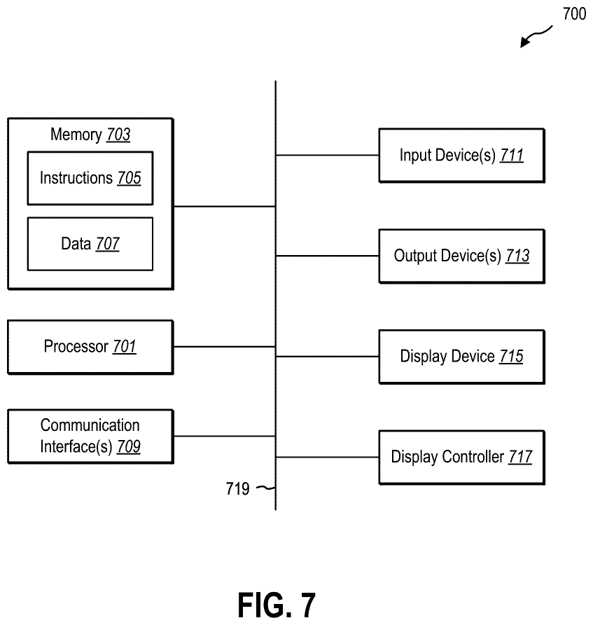

FIG. 7 illustrates components that may be included within a computer system 700. One or more computer systems 700 may be used to implement the various methods, devices, components, and/or systems described herein.

The computer system 700 includes a processor 701. The processor 701 may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 701 may be referred to as a central processing unit (CPU). Although just a single processor 701 is shown in the computer system 700 of FIG. 7, in an alternative configuration, a combination of processors (e.g., an ARM and DSP) could be used.

The computer system 700 also includes memory 703 in electronic communication with the processor 701. The memory 703 may be any electronic component capable of storing electronic information. For example, the memory 703 may be embodied as random access memory (RAM), read-only memory (ROM), magnetic disk storage mediums, optical storage mediums, flash memory devices in RAM, on-board memory included with the processor, erasable programmable read-only memory (EPROM), electrically erasable programmable read-only memory (EEPROM) memory, registers, and so forth, including combinations thereof.

Instructions 705 and data 707 may be stored in the memory 703. The instructions 705 may be executable by the processor 701 to implement some or all of the functionality disclosed herein. Executing the instructions 705 may involve the use of the data 707 that is stored in the memory 703. Any of the various examples of modules and components described herein may be implemented, partially or wholly, as instructions 705 stored in memory 703 and executed by the processor 701. Any of the various examples of data described herein may be among the data 707 that is stored in memory 703 and used during execution of the instructions 705 by the processor 701.

A computer system 700 may also include one or more communication interfaces 709 for communicating with other electronic devices. The communication interface(s) 709 may be based on wired communication technology, wireless communication technology, or both. Some examples of communication interfaces 709 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 700 may also include one or more input devices 711 and one or more output devices 713. Some examples of input devices 711 include a keyboard, mouse, microphone, remote control device, button, joystick, trackball, touchpad, and lightpen. Some examples of output devices 713 include a speaker and a printer. One specific type of output device that is typically included in a computer system 700 is a display device 715. Display devices 715 used with embodiments disclosed herein may utilize any suitable image projection technology, such as liquid crystal display (LCD), light-emitting diode (LED), gas plasma, electroluminescence, or the like. A display controller 717 may also be provided, for converting data 707 stored in the memory 703 into text, graphics, and/or moving images (as appropriate) shown on the display device 715.

In some implementations, the various components of the computer system 700 are implemented as one device. For example, the various components of the computer system 700 are implemented in a mobile phone or tablet. Another example includes the various components of the computer system 700 implemented in a personal computer.

The various components of the computer system 700 may be coupled together by one or more buses, which may include a power bus, a control signal bus, a status signal bus, a data bus, etc. For clarity, the various buses are illustrated in FIG. 7 as a bus system 719.

As illustrated in the foregoing discussion, the present disclosure utilizes a variety of terms to describe features and advantages of the model evaluation system. Additional detail is now provided regarding the meaning of such terms. For example, as used herein, a “machine learning model” refers to a computer algorithm or model (e.g., a classification model, a clustering model, a regression model, a language model, an object detection model) that can be tuned (e.g., trained) based on training input to approximate unknown functions. For example, a machine learning model may refer to a neural network (e.g., a convolutional neural network (CNN), deep neural network (DNN), recurrent neural network (RNN)), or other machine learning algorithm or architecture that learns and approximates complex functions and generates outputs based on a plurality of inputs provided to the machine learning model. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

Computer-readable mediums may be any available media that can be accessed by a general purpose or special purpose computer system. Computer-readable mediums that store computer-executable instructions are non-transitory computer-readable storage media (devices). Computer-readable mediums that carry computer-executable instructions are transmission media. Thus, by way of example, and not limitation, implementations of the disclosure can comprise at least two distinctly different kinds of computer-readable mediums: non-transitory computer-readable storage media (devices) and transmission media.

As used herein, non-transitory computer-readable storage mediums (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database, a datastore, or another data structure), ascertaining and the like. Also, “determining” can include receiving (e.g., receiving information), accessing (e.g., accessing data in a memory) and the like. Also, “determining” can include resolving, selecting, choosing, establishing, predicting, inferring, and the like.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one implementation” or “an implementation” of the present disclosure are not intended to be interpreted as excluding the existence of additional implementations that also incorporate the recited features. For example, any element described in relation to an implementation herein may be combinable with any element of any other implementation described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the implementations that falls within the meaning and scope of the claims is to be embraced by the claims.

The present disclosure may be embodied in other specific forms without departing from its spirit or characteristics. The described implementations are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method, comprising:
receiving an input query with a topic for a document;
generating, by a large language model, a framework with sections and subsections for the document;
writing, by the large language model, the sections and the subsections of the document with natural language and references to data sources used to obtain data that the large language model used to write the document; and
providing the document in response to the input query.

2. The method of claim 1, further comprising:
receiving a modification to the framework for the document; and
generating an updated framework in response to the modification, wherein the large language model uses the updated framework to write the sections and the subsections of the document.

3. The method of claim 2, wherein the modification is an addition of a section, an addition of a subsection, a removal of a section, a removal of a subsection, editing a section, or editing a subsection.

4. The method of claim 1, wherein the input query further includes areas of focus for the topic and the sections and the subsections include additional content for the areas of focus.

5. The method of claim 1, wherein the input query further includes a set of data sources to use in providing the data for the document.

6. The method of claim 5, wherein the set of data sources are trusted data sources.

7. The method of claim 1, wherein the data sources includes a combination of publicly available data sources and private data sources.

8. The method of claim 1, further comprising:
automatically generating, by the large language model, a list of references at an end of the document with citations to the data sources used in generating the document, wherein the references within the sections and the subsections correspond to the list of references.

9. The method of claim 1, further comprising:
providing, to the large language model, a system prompt that includes a chain of thought for preparing the document, a goal for the document, and a length of the document, wherein the large language model uses the system prompt in writing the sections and the subsections of the document.

10. The method of claim 1, further comprising:
providing, to the large language model, a preparation prompt that the large language model uses to identify information needed to prepare the document, wherein the large language model uses the preparation prompt to identify the information; and
sending a retrieval request for the data to use in writing the document based on the information.

11. The method of claim 1, further comprising:
providing, to the large language model, a section writing prompt that provides additional instructions to the large language model for writing the sections and the subsections of the document, wherein the large language model uses the section writing prompt to write the sections and the subsections of the document.

12. The method of claim 1, wherein the sections or the subsections further include figures or tables automatically created by the large language model.

13. The method of claim 1, wherein the document is a report on the topic, a grounded technical report on the topic, a contract, a funding proposal, a clinical trial protocol, or product documentation.

14. A device, comprising:
a memory to store data and instructions; and
a processor operable to communicate with the memory, wherein the processor is operable to:
receive an input query with a topic for a document;
generate, by a large language model, a framework with sections and subsections for the document;
write, by the large language model, the sections and the subsections of the document with natural language and references to data sources used to obtain data that the large language model used to write the document; and
provide the document in response to the input query.

15. The device of claim 14, wherein the processor is further operable to:
receive a modification to the framework for the document, wherein the modification is an addition of a section, an addition of a subsection, a removal of a section, a removal of a subsection, editing a section, or editing a subsection; and
generate an updated framework in response to the modification, wherein the large language model uses the updated framework to write the sections and the subsections of the document.

16. The device of claim 14, wherein the input query further includes areas of focus for the topic and the sections and the subsections include additional content for the areas of focus.

17. The device of claim 14, wherein the input query further includes a set of data sources to use in providing the data for the document, wherein the set of data sources includes a combination of publicly available data sources and private data sources.

18. The device of claim 14, wherein the processor is further operable to:
automatically generate, by the large language model, a list of references at an end of the document with citations to the data sources used in generating the document, wherein the references within the sections and the subsections correspond to the list of references.

19. The device of claim 14, wherein the processor is further operable to:
providing, to the large language model, a system prompt that includes a chain of thought for preparing the document, a goal for the document, and a length of the document, wherein the large language model uses the system prompt in writing the sections and the subsections of the document; and
provide, to the large language model, a section writing prompt that provides additional instructions to the large language model for writing the sections and the subsections of the document, wherein the large language model uses the section writing prompt to write the sections and the subsections of the document.

20. The device of claim 14, wherein the processor is further operable to:
provide, to the large language model, a preparation prompt that the large language model uses to identify information needed to prepare the document, wherein the large language model uses the preparation prompt to identify the information; and
send a retrieval request for the data to use in writing the document based on the information.
